(19) United States
(12) Patent Application Publication
(10) Pub. No.: US 2021/0224692 A1
(43) Pub. Date: Jul. 22, 2021

(54) HYPERPARAMETER TUNING METHOD, DEVICE, AND PROGRAM

(71) Applicant: Preferred Networks, Inc., Tokyo (JP)

(72) Inventor: Takuya AKIBA, Tokyo (JP)

(21) Appl. No.: 17/221,060

(22) Filed: Apr. 2, 2021

Related U.S. Application Data
(63) Continuation of application No. PCT/JP2019/039338, filed on Oct. 4, 2019.

(30) Foreign Application Priority Data
Oct. 9, 2018 (JP) 2018-191250

(51) Int. Cl. G06N 20/00; G06N 7/00

(52) U.S. Cl. CPC G06N 20/00; G06N 7/005

(57) ABSTRACT

A hyperparameter tuning method for execution by one or more processors includes receiving a request to obtain a hyperparameter, the request being generated according to a hyperparameter obtaining code, and the hyperparameter obtaining code being written in a user program, and providing the hyperparameter to the user program based on an application history of hyperparameters applied to the user program.

### CROSS-REFERENCE TO RELATED APPLICATIONS

This application is a continuation application of International Application No. PCT/JP2019/039338 filed on Oct. 4, 2019, and designating the U.S., which is based upon and claims priority to Japanese Patent Application No. 2018-191250, filed on Oct. 9, 2018, the entire contents of which are incorporated herein by reference.

### BACKGROUND

### 1. Technical Field

The present disclosure relates to an information processing technology.

### 2. Description of the Related Art

When executing a program, parameters defining operation conditions of the program may be often externally set. Because values set in the parameters may affect execution results or performance of the program, appropriate parameters may be required to be set. Such externally set parameters may be referred to as hyperparameters to distinguish the externally set parameters from parameters set or updated within the program.

For example, in machine learning such as deep learning, parameters of machine learning models that characterize problems to be learned may be learned based on learning algorithms. Separately from such parameters to be learned, hyperparameters may be set when a machine learning model is selected or a learning algorithm is executed. Specific examples of hyperparameters for machine learning may include parameters used in a particular machine learning model (e.g., a learning rate, a learning period, a noise rate, a weight decay coefficient, and the like in a neural network). When several machine learning models are used, specific examples of hyperparameters may include a type of a machine learning model, parameters used to construct respective types of machine learning models (e.g., the number of layers in a neural network, depth of a tree in a decision tree, and the like), and the like. By setting appropriate hyperparameters, predictive performance, generalization performance, learning efficiency, and the like can be improved.

### SUMMARY

According to one aspect of the present disclosure, a hyperparameter tuning method for execution by one or more processors includes receiving a request to obtain a hyperparameter, the request being generated according to a hyperparameter obtaining code, and the hyperparameter obtaining code being written in a user program, and providing the hyperparameter to the user program based on an application history of hyperparameters applied to the user program.

### BRIEF DESCRIPTION OF THE DRAWINGS

FIG. 1 is a schematic view illustrating hyperparameter settings according to a define-by-run scheme of the present disclosure;

FIG. 2 is a block diagram illustrating a hardware configuration of a hyperparameter tuning device according to an embodiment of the present disclosure;

FIG. 3 is a flowchart illustrating a hyperparameter tuning process according to the embodiment of the present disclosure;

FIG. 4 is a sequence diagram illustrating the hyperparameter tuning process according to the embodiment of the present disclosure;

FIG. 5 is a drawing illustrating a hyperparameter obtaining code according to the embodiment of the present disclosure; and

FIG. 6 is a drawing illustrating a hyperparameter obtaining code according to another embodiment of the present disclosure;

### DETAILED DESCRIPTION

In the following embodiment, a hyperparameter tuning device and a method of setting a hyperparameter used during program execution will be disclosed.

An outline of the present disclosure is that a hyperparameter tuning device may be implemented by a hyperparameter tuning program or software, and, upon receiving a request to obtain a hyperparameter from a user program, the hyperparameter tuning device provides, based on an application history of hyperparameters applied to the user program, the hyperparameter to the user program. Here, the user program may generate a hyperparameter obtaining request for obtaining a hyperparameter to be obtained according to a hyperparameter obtaining code written in the user program, and sequentially may request the hyperparameter to be obtained to the hyperparameter tuning program based on the generated hyperparameter obtaining request.

The following embodiment focuses on hyperparameters used in a training process of a machine learning model. However, the hyperparameters of the present disclosure may be any hyperparameter that may affect execution results or performance of the user program.

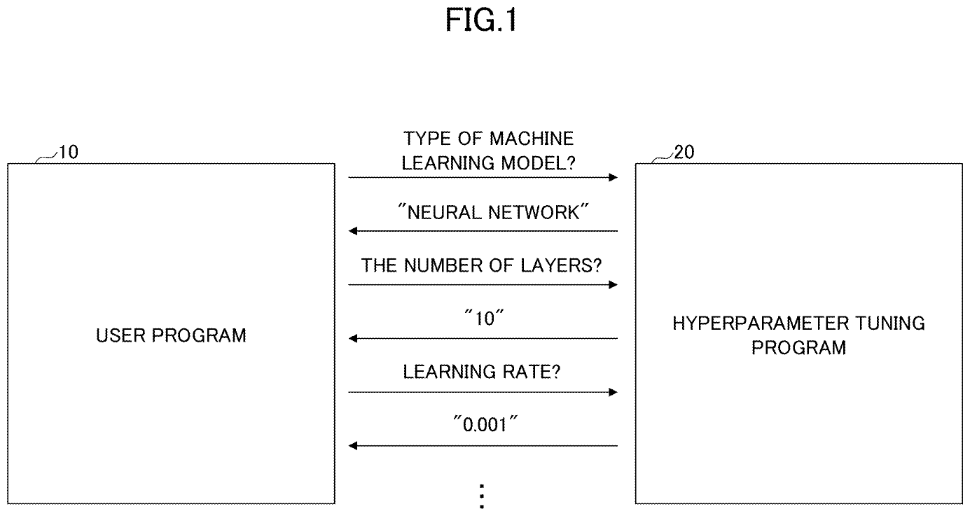

The hyperparameter obtaining code according to the present disclosure can be written by using a control structure in which a conditional branch, such as an if statement, and a repeat process, such as a for statement, can be performed. Specifically, as illustrated in FIG. 1, a user program 10 first may request “a type of machine learning model” to a hyperparameter tuning program 20 as a hyperparameter, and, in response to the hyperparameter obtaining request from the user program 10, the hyperparameter tuning program 20 may return, for example, “a neural network” as “the type of a machine learning model”. When “the neural network” is selected as “the type of the machine learning model”, the user program 10 may request various hyperparameters required for “the neural network” (e.g., the number of layers, a learning rate, and so on) according to a control structure of the hyperparameter obtaining code. As described, according to the present disclosure, the hyperparameters may be set by a define-by-run scheme.

When a combination of hyperparameters required for the training process is set, the user program 10 may apply the obtained combination of hyperparameters to train the machine learning model and provides accuracy, such as predictive performance of the trained machine learning model, to the hyperparameter tuning program 20. The above-described process may be repeated until a predetermined termination condition is satisfied.

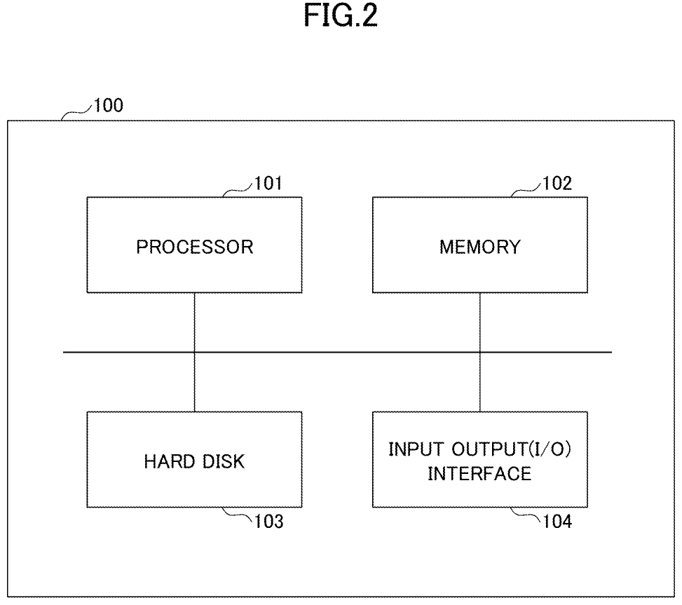

First, with reference to FIGS. 2 to 4, a hyperparameter tuning process according to an embodiment of the present disclosure will be described. In the present embodiment, a hyperparameter tuning device 100 may perform the process and, more specifically, a processor of the hyperparameter tuning device 100 may execute the hyperparameter tuning program 20 to perform the process.

Here, as illustrated in FIG. 2, for example, the hyperparameter tuning device 100 may have a hardware configuration in which a processor 101, such as a central processing unit (CPU) and a graphics processing unit (GPU), a memory 102, such as a random access memory (RAM) and a flash memory, a hard disk 103, and an input output (I/O) interface 104 are provided.

The processor 101 executes various processes of the hyperparameter tuning device 100 and also may execute the user program 10 and/or the hyperparameter tuning program 20.

The memory 102 may store various data and a program for the hyperparameter tuning device 100, and the user program 10 and/or the hyperparameter tuning program 20, and functions as a working memory, particularly for work data, a running program, and the like. Specifically, the memory 102 may store the user program 10 and/or the hyperparameter tuning program 20 loaded from the hard disk 103 and functions as a working memory while the processor 101 executes the program.

The hard disk 103 may store the user program 10 and/or the hyperparameter tuning program 20.

The I/O interface 104 may be an interface for inputting data to an external device and outputting data from the external device. For example, the I/O interface 104 may be a device for inputting and outputting data such as a universal serial bus (USB), a communication line, a keyboard, a mouse, and a display.

However, the hyperparameter tuning device 100 according to the present disclosure is not limited to the hardware configuration described above, and may have any other suitable hardware configuration. For example, some or all of the hyperparameter tuning processes performed by the hyperparameter tuning device 100 described above may be performed by a processing circuit or an electronic circuit wired to achieve some or all of the hyperparameter tuning processes.

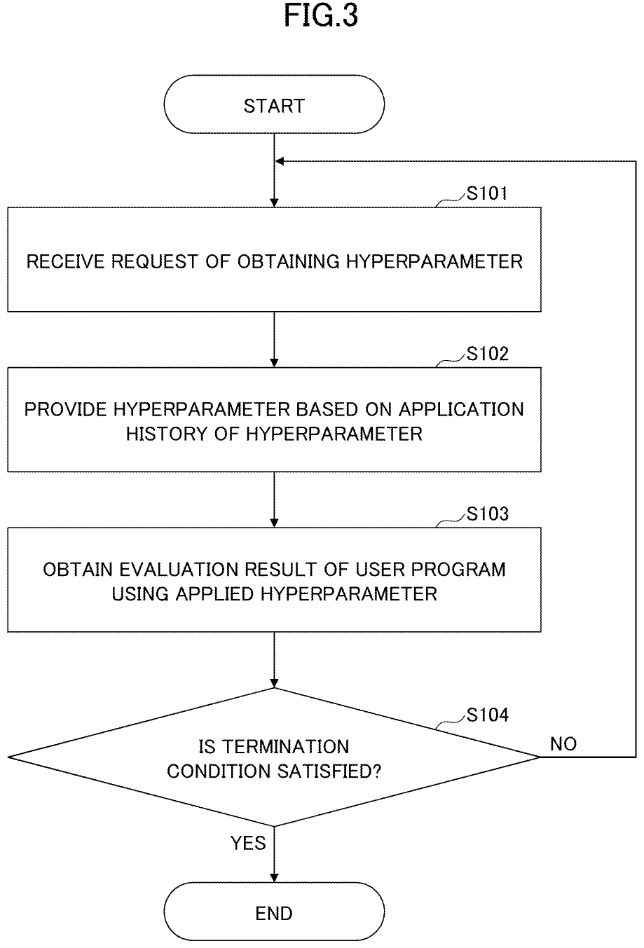

FIG. 3 is a flowchart illustrating a hyperparameter tuning process according to the embodiment of the present disclosure. The hyperparameter tuning process may be implemented by the hyperparameter tuning device 100 executing the hyperparameter tuning program 20 upon the user program 10, written by using, for example, a machine learning library such as Chainer or TensorFlow, being started.

As illustrated in FIG. 3, in step S101, the hyperparameter tuning program 20 may receive a hyperparameter obtaining request.

Specifically, the user program 10 may determine a hyperparameter to be obtained according to a hyperparameter obtaining code described in the user program, may generate the hyperparameter obtaining request for the hyperparameter, and may transmit the generated hyperparameter obtaining request to the hyperparameter tuning program 20, and the hyperparameter tuning program 20 may receive the hyperparameter obtaining request from the user program 10.

In the embodiment, the hyperparameter obtaining code may be written using a control structure having, for example, a sequence, a conditional statement, and/or a loop statement. Specifically, the hyperparameter obtaining code can be written using an if statement or a for statement. For example, if the hyperparameter tuning program 20 sets “the type of the machine learning model” to “the neural network” as the hyperparameter, the user program 10 may determine a hyperparameter specific to “the neural network” (e.g., the number of layers, the number of layer nodes, a weight decay coefficient, and so on) as a hyperparameter to be obtained next according to the control structure of the hyperparameter obtaining code. Alternatively, if the hyperparameter tuning program 20 sets “the type of the machine learning model” to “a decision tree” as the hyperparameter, the user program 10 may determine a hyperparameter specific to “the decision tree” (e.g., tree depth, the number of edges branched from a node, and so on) as a hyperparameter to be obtained next according to the control structure of the hyperparameter obtaining code. As described, the user program 10 can determine the hyperparameter to be obtained next according to the control structure written in the user program 10 and can generate a hyperparameter obtaining request for the determined hyperparameter.

In step S102, the hyperparameter tuning program 20 may provide the hyperparameter based on an application history of hyperparameters.

Specifically, upon receiving the hyperparameter obtaining request for a hyperparameter from the user program 10, the hyperparameter tuning program 20 may determine a value of the requested hyperparameter based on the application history of hyperparameters previously applied to the user program 10, and may return the determined value of the hyperparameter to the user program 10. For example, if the hyperparameter obtaining request is for a learning rate, the hyperparameter tuning program 20 may refer to values of the learning rate and/or other hyperparameter values previously set to the user program 10 to determine a value of the learning rate to be applied next, and may return the determined value of the learning rate to the user program 10. Upon obtaining the value of the learning rate, the user program 10 may determine whether an additional hyperparameter is required to perform the training process on the machine learning model according to the hyperparameter obtaining code. If the additional hyperparameter (e.g., a learning period, a noise rate, and so on) is required, the user program 10 may generate a hyperparameter obtaining request for the hyperparameter and transmits the generated hyperparameter obtaining request to the hyperparameter tuning program 20. The user program 10 may continue to transmit the hyperparameter obtaining request until the required combination of hyperparameters are obtained, and the hyperparameter tuning program 20 may repeat steps S101 and S102 described above in response to the received hyperparameter obtaining request.

In the embodiment, the hyperparameter tuning program 20 may provide a hyperparameter selected according to a predetermined hyperparameter selection algorithm.

Specifically, the hyperparameter selection algorithm may be based on Bayesian optimization utilizing the accuracy of the machine learning model obtained under the application history of the hyperparameters. As will be described later, upon obtaining the combination of hyperparameters required for the training process, the user program 10 may apply the combination of hyperparameters set by the hyperparameter tuning program 20 to train the machine learning model. The user program 10 may determine the accuracy, such as the predictive performance of the machine learning model that is trained under the set combination of hyperparameters, and provide the determined accuracy to the hyperparameter tuning program 20. The hyperparameter tuning program 20 may store the previously set combinations of hyperparameters and the accuracy acquired for the respective combinations as the application history, and may use the stored application history as prior information to determine the hyperparameter to be set next based on Bayesian optimization or Bayesian inference. By using Bayesian optimization, a more appropriate combination of hyperparameters can be set using the application history as the prior information.

Alternatively, the predetermined hyperparameter selection algorithm may be based on random search. In this case, the hyperparameter tuning program 20 randomly may set a combination of hyperparameters that has not been previously applied, referring to the application history. By using random search, the hyperparameters can be set by a simple hyperparameter selection algorithm.

The hyperparameter tuning program 20 may also combine the Bayesian optimization with the random search described above to determine the combination of hyperparameters. For example, if only Bayesian optimization is used, the combination may converge to a local optimal combination, and if only random search is used, a combination that significantly deviates from the optimal combination may be selected. A combination of two hyperparameter selection algorithms that are the Bayesian optimization and the random search may be applied to reduce the above-described problems.

The hyperparameter selection algorithm according the present disclosure may be the Bayesian optimization and the random search described above, and may be any other suitable hyperparameter selection algorithms including evolutionary computation, grid search, and the like.

In step S103, the hyperparameter tuning program 20 may obtain an evaluation result of the user program based on the applied hyperparameters. Specifically, upon the user program 10 obtaining the combination of hyperparameters required to perform the training process, the user program 10 may apply the combination of hyperparameters to perform the training process on the machine learning model. Upon completing the training process, the user program 10 may calculate the accuracy, such as predictive performance of the machine learning model, obtained as a result, and may provide the calculated accuracy, as the evaluation result, to the hyperparameter tuning program 20.

In step S104, it may be determined whether the termination condition is satisfied, and if the termination condition is satisfied (S104:YES), the hyperparameter tuning process may be terminated. If the termination condition is not satisfied (S104:NO), the hyperparameter tuning process may return to steps S101 and S102, and the user program 10 may obtain a new combination of hyperparameters. Here, the termination condition may be, for example, that the number of applications of the combination of hyperparameters has reached a predetermined threshold. The processing in step S104 may also be typically written in a main program controlling the user program 10 and the hyperparameter tuning program 20.

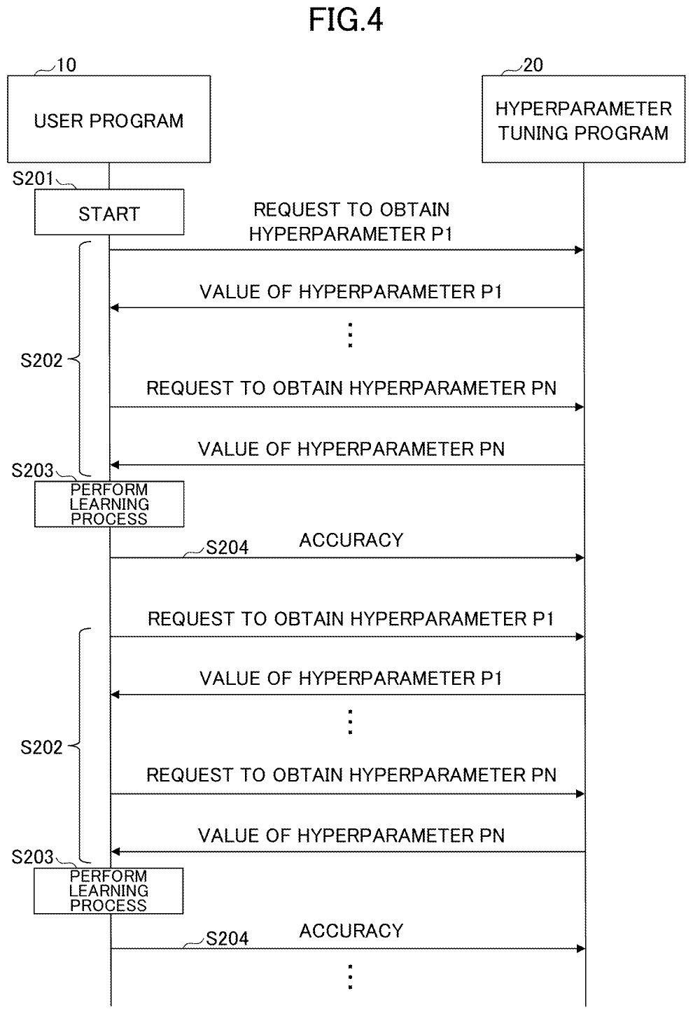

FIG. 4 is a sequence diagram illustrating the hyperparameter tuning process according to the embodiment of the present disclosure. Here, the hyperparameter tuning process described above with reference to FIG. 3 will be described from the viewpoint of data exchange between the user program 10 and the hyperparameter tuning program 20.

As illustrated in FIG. 4, in step S201, the user program 10 may be started and parameters to be updated in the machine learning model are initialized.

In step S202, the user program 10 may determine a hyperparameter P1 to be obtained according to the hyperparameter obtaining code written in the user program 10 and may transmit a hyperparameter obtaining request for the hyperparameter P1 to the hyperparameter tuning program 20. Upon receiving the hyperparameter obtaining request, the hyperparameter tuning program 20 may determine a value of the hyperparameter P1 and may return the determined value of the hyperparameter P1 to the user program 10. Upon obtaining the value of the hyperparameter P1, similarly, the user program 10 may determine a hyperparameter P2 to be further obtained according to the control structure of the hyperparameter obtaining code and may transmit the hyperparameter obtaining request for the hyperparameter P2 to the hyperparameter tuning program 20. Upon receiving the hyperparameter obtaining request, the hyperparameter tuning program 20 may determine a value of the hyperparameter P2 and may return the determined value of the hyperparameter P2 to the user program 10. Similarly, the user program 10 and the hyperparameter tuning program 20 may repeat the above-described exchange until a combination of hyperparameters (P1, P2, . . . , PN) required to train the machine learning model is obtained.

Although each of the hyperparameter obtaining requests illustrated in the drawing requests a single hyperparameter, each of the hyperparameter obtaining requests may request multiple hyperparameters. For example, because hyperparameters such as a learning rate, a learning period, a noise rate, and the like can be set independently of one another, these hyperparameters may be requested together by a single hyperparameter obtaining request. With respect to the above, a hyperparameter, such as a type of a machine learning model, a learning algorithm, or the like may be requested by a single hyperparameter obtaining request because the hyperparameter may affect the selection of other hyperparameters.

In step S203, the user program 10 may apply the obtained combination of hyperparameters to train the machine learning model. Upon completing the training process, the user program 10 may calculate the accuracy of the machine learning model, such as predictive performance obtained as a result.

In step S204, the user program 10 may provide the calculated accuracy to the hyperparameter tuning program 20 as the evaluation result. The hyperparameter tuning program 20 may store the previously obtained accuracy as the application history in association with the applied combination of hyperparameters, and may use the application history to select subsequent hyperparameters.

Steps S202 to S204 may be repeated until the termination condition that the steps have been performed a predetermined number of times, for example, is satisfied.

In the embodiment, the hyperparameter obtaining request may request the type of machine learning model and a hyperparameter specific to the type of the machine learning model according to the control structure.

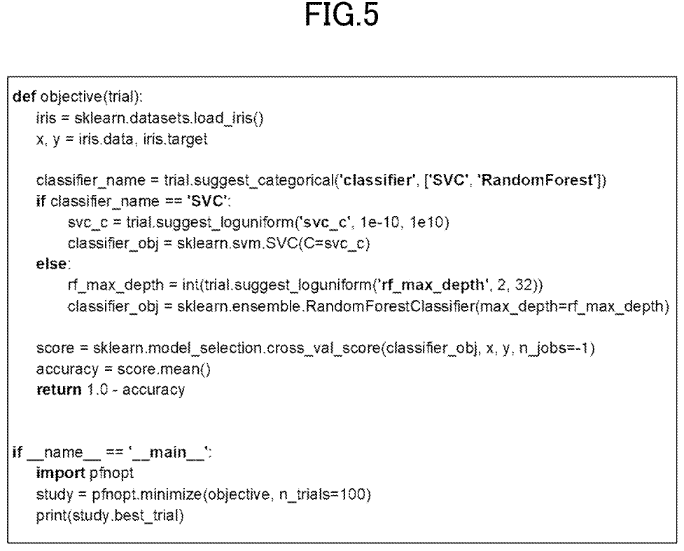

For example, the hyperparameter obtaining request may be generated according to a hyperparameter obtaining code illustrated in FIG. 5. First, “a type of the machine learning model” or “a type of the classifier” may be obtained as the hyperparameter. In the example illustrated in the drawing, the user program 10 may query, to the hyperparameter tuning program 20, whether the “support vector classification (SVC)” or “random forest” should be applied.

If the hyperparameter tuning program 20 selects the “SVC”, the user program 10 may transmit a hyperparameter obtaining request for “svc_c” as an additional hyperparameter to the hyperparameter tuning program 20. If the hyperparameter tuning program 20 selects “random forest”, the user program 10 may transmit a hyperparameter obtaining request for “rf_max_depth” as an additional hyperparameter to the hyperparameter tuning program 20.

Subsequently, the user program 10 may apply the obtained hyperparameter to perform the training process on the machine learning model, may calculate the accuracy or error of the machine learning model obtained as a result, and may transmit the accuracy or the error to the hyperparameter tuning program 20. The number of trials (n_trial) may be defined in the main program, and in the example illustrated in the drawing, the above process is repeated 100 times.

As described, according to the present disclosure, in comparison with existing hyperparameter tuning software, the maintainability of the program for the user can be improved by writing the hyperparameter obtaining code defining the hyperparameter to be obtained in the user program 10 that uses the hyperparameter, instead of the hyperparameter tuning software. Additionally, a complex control structure such as a conditional branch can be used to request and obtain appropriate hyperparameters corresponding to sequentially selected hyperparameters.

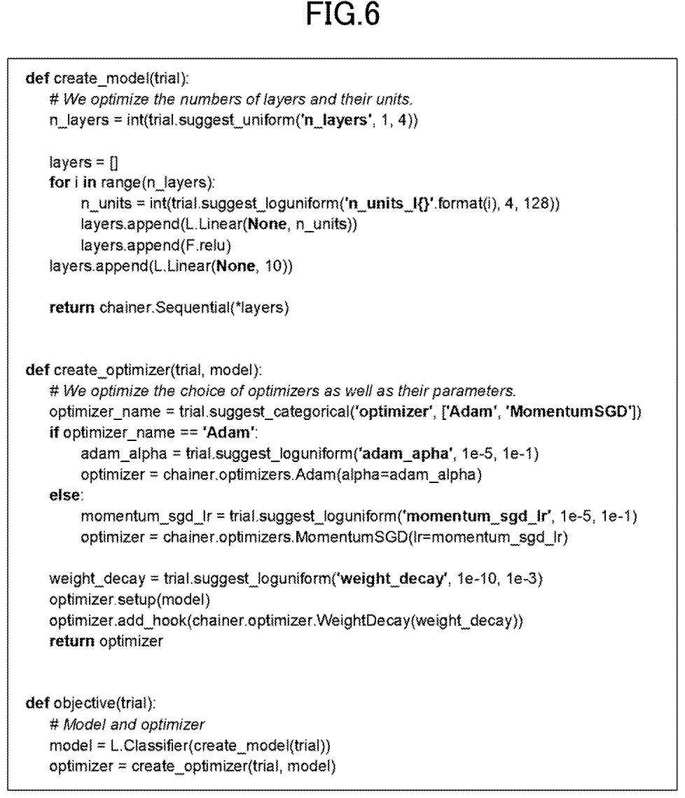

In the embodiment, the hyperparameter obtaining code may include a module for setting hyperparameters defining a structure of the machine learning model and a module for setting hyperparameters defining a training process of the machine learning model. For example, in the hyperparameter obtaining code, as illustrated in FIG. 6, a module relating to construction of the machine learning model (def create_model) and a module for setting hyperparameters of the machine learning model (def create_optimizer) can be written separately.

As described, according to the present disclosure, the hyperparameter obtaining code can be modularized by different modules, thereby facilitating the collaboration of multiple programmers to create the hyperparameter obtaining code.

In the above-described embodiment, a hyperparameter tuning technique of setting hyperparameters to the user program for training the machine learning model has been described. However, the user program according to the present disclosure may be any program. That is, the hyperparameter tuning technique according to the present disclosure can be applied to the setting of any hyperparameters that affects execution results or performance of the user program. For example, as application examples other than machine learning, increasing the speed of a program and improving a user interface may be considered. For example, with respect to the speed of the program, a value such as a utilized algorithm and a buffer size may be used as hyperparameters, and the speed of the program can be increased by optimizing the hyperparameters so as to increase the speed. When designing a user interface, the location and size of buttons may be used as hyperparameters, and the user interface can be improved by optimizing the hyperparameters to improve a user's behavior.

Although the embodiment of the present invention has been described in detail above, the present invention is not limited to the specific embodiment described above, and various modifications and variations can be made within the scope of the subject matter of the present invention as claimed.

What is claimed is:

1. A hyperparameter tuning method for execution by one or more processors, comprising:
receiving a request to obtain a hyperparameter, the request being generated according to a hyperparameter obtaining code, and the hyperparameter obtaining code being written in a user program; and
providing the hyperparameter to the user program based on an application history of hyperparameters applied to the user program.

2. The hyperparameter tuning method as claimed in claim 1, wherein the hyperparameter obtaining code is written using a control structure.

3. The hyperparameter tuning method as claimed in claim 2,
wherein the user program determines a hyperparameter to be obtained subsequent to the provided hyperparameter, according to the written control structure, and
wherein the user program generates a request to obtain the determined hyperparameter.

4. The hyperparameter tuning method as claimed in claim 1, wherein the user program is for training a machine learning model.

5. The hyperparameter tuning method as claimed in claim 4, wherein the request to obtain the hyperparameter requests a type of the machine learning model and a hyperparameter specific to the type of the machine learning model, according to a control structure.

6. The hyperparameter tuning method as claimed in claim 4, wherein the hyperparameter obtaining code includes a module for setting a hyperparameter that defines a structure of the machine learning model, and a module for setting a hyperparameter that defines a training process of the machine learning model.

7. The hyperparameter tuning method as claimed in claim 1, wherein the providing of the hyperparameter provides a hyperparameter selected based on a predetermined hyperparameter selection algorithm.

8. The hyperparameter tuning method as claimed in claim 7, wherein the predetermined hyperparameter selection algorithm is based on Bayesian optimization.

9. The hyperparameter tuning method as claimed in claim 7, wherein the predetermined hyperparameter selection algorithm is based on a random search.

10. The hyperparameter tuning method as claimed in claim 1, further comprising obtaining an evaluation result of the user program to which the hyperparameter is applied.

11. The hyperparameter tuning method as claimed in claim 10, wherein the evaluation result of the user program includes accuracy of a machine learning model.

12. The hyperparameter tuning method as claimed in claim 1, further comprising repeating the receiving of the request and the providing of the hyperparameter until a termination condition is satisfied.

13. A hyperparameter tuning method for execution by one or more processors, comprising:
receiving a request to obtain a hyperparameter, the request being generated according to a hyperparameter obtaining code, and the hyperparameter obtaining code being written in a user program; and
providing the hyperparameter to the user program based on the request to obtain the hyperparameter.

14. The hyperparameter tuning method as claimed in claim 13, comprising performing the receiving of the request and the providing of the hyperparameter until the user program obtains a hyperparameter necessary for an evaluation.

15. The hyperparameter tuning method as claimed in claim 13, wherein the hyperparameter obtaining code defines a hyperparameter to be tuned and a range of a value of the hyperparameter to be tuned.

16. A method of generating a computer program using the hyperparameter tuning method as claimed in claim 1.

17. The method as claimed in claim 16, wherein the computer program is a machine learning model.

18. A hyperparameter tuning device comprising one or more processors, wherein the one or more processors are configured to:
receive a request to obtain a hyperparameter, the request being generated according to a hyperparameter obtaining code, and the hyperparameter obtaining code being written in a user program; and
provide the hyperparameter to the user program based on an application history of hyperparameters applied to the user program.

19. A hyperparameter tuning device comprising one or more processors, wherein the one or more processors are configured to:
receive a request to obtain a hyperparameter, the request being generated according to a hyperparameter obtaining code, and the hyperparameter obtaining code being written in a user program; and
provide the hyperparameter to the user program based on the request to obtain the hyperparameter.

20. The device as claimed in claim 19, wherein the user program is for training a machine learning model.
